(19) United States
(12) Patent Application Publication
(10) Pub. No.: US 2002/0065909 A1
(43) Pub. Date: May 30, 2002

(54) DSL demo kiosk

(76) Inventor: Pil Kyu Han, Fairfax, VA (US)

Correspondence Address: Leonard C Suchyta, c/o Christian R Anderson, Verizon Services Group, 600 Hidden Ridge Drive Mail Code HQE03H01, Irving, TX, 75038, US

(21) Appl. No.: 09/725,619

(22) Filed: Nov. 29, 2000

(51) Int. Cl. G06F 15/173; G06F 15/16

(52) U.S. Cl. 709/224; 709/230

(57) ABSTRACT

A Digital Subscriber Line (DSL) demonstration kiosk located in a store is configured to transmit its dynamically allocated Internet Protocol (IP) address to a centrally located monitoring computer. The centrally located monitoring computer receives the IP address, and starts to “ping” the kiosk to determine if the kiosk is “alive.” The centrally located monitoring system additionally tracks the usage and usability of the kiosk, and receives information on whether a sale of a demonstrated service has taken place, and if so, which kiosk location or salesperson was responsible for the sale.

### TECHNICAL FIELD

The present invention is directed toward self-service kiosk systems in general, and in particular to a kiosk that allows demonstration of certain telephony capabilities such as Digital Subscriber Line (DSL) while allowing a service provider to monitor its usage and usability.

### BACKGROUND

A kiosk is a self-service station, typically used by a user to purchase things such as candy, soda, fast food, postage stamps and the like. In general, a service provider operates a kiosk and equips the kiosk with product and ways to purchase the product, such as by depositing coins in a designated slot.

Recently, coin-operated television viewing has become available at airports and other places at which the general public can obtain information. Similarly, web browser kiosks have become available to enable potential customers to try out new services such as web browsing.

U.S. Pat. No. 6,078,848 to Bernstein et al. describes a stand-alone browser kiosk system comprising a self-service client computer, which is programmed for a tamper-resistant design by preventing users from accessing unauthorized functions with respect to documents displayed on the computer's screen.

Another stand-alone computer system is described in U.S. Pat. No. 5,602,905 to Mettke, which system is directed toward a “pay-as-you-see” communication terminal capable of interfacing with all major commercial on-line communications services (i.e., America On-Line™, etc). A co-located printer provides users with a hard copy of any activity they conduct. Services are paid-for by means of a credit card, using a magnetic swipe system, which is included as a part of the terminal system.

In contradistinction to these stand-alone kiosks, if a kiosk could be monitored from a centrally located service provider station, the kiosk's availability, usage and usability can be tracked, which may enable a service provider to optimize the use of each kiosk. Accordingly, there is a need to improve the state of the art.

### SUMMARY

When demonstrating the capabilities of a digital subscriber line (DSL) or other similar technology, it is advantageous to monitor whether the line is active or not. Traditional web kiosk technologies demonstrate web surfing experiences. Such traditional systems merely establish a dial-up telephone connection with an Internet Service Provider (ISP). In contrast to the traditional systems, in accordance with the principles disclosed herein, a user is allowed to additionally evaluate the speed of the DSL connection.

In the case of DSL, typically, the telephone company that provides the dial-up connection and the ISP could be the same entity. Further, the DSL line is configured to carry voice signals in a lower 4 KHZ of frequency spectrum, and multiplexed data signals in an upper frequency spectrum, using, for example, discrete multi-tone (DMT) or other technologies. Because of these differences, a kiosk that demonstrates DSL-like technologies may be advantageously monitored from a central monitoring station.

In an embodiment, the present invention is directed toward centrally monitoring a kiosk system. Examining traffic from a particular Internet Protocol (IP) address can do this monitoring. Thus, the monitoring can be easy when the IP address is static, i.e., it does not change over time. But in some cases, IP addresses are dynamically allocated, which complicates the monitoring process. One way to alleviate this problem is to program each kiosk to communicate its IP address to a centrally located monitoring system after a restart. Thus, when the kiosk system crashes or goes off-line, the centrally located monitoring system receives an indication that the kiosk has crashed or is off-line. Automatic rebooting capability is programmed into the kiosk, whereby the kiosk “wakes up” after a set of instructions for automatic booting is executed. At that point, the kiosk system sends a notification to the centrally monitoring system. Thereafter, the central monitoring system tracks, and monitors the usage and usability of the kiosk system.

In another embodiment, the present invention is directed toward a programmed microprocessor to initiate a notification message from the kiosk system to the centrally located monitoring system. This notification message may provide the kiosk's IP address, identification information, its location, and any profile information that assists the centrally located monitoring system to start tracking user activities at the kiosk. The notification message is also recorded in a database coupled to the centrally located monitoring system, whereby a system administrator could prepare statistical reports on demand or on a periodic basis to assist a manager to identify kiosks that require maintenance, upgrade or other services.

Another embodiment is directed to receiving sales information from a store or other location, when a user purchases DSL service from a kiosk. The centrally located monitoring system receives and stores this information in the database. The sales information can be used, among other things, to track the effectiveness of kiosks, and to credit a particular store or salesperson for generating the sale.

### BRIEF DESCRIPTION OF THE DRAWINGs

These and other objects, features and advantages of the principles of the present invention are more readily understood from the following detailed description and the accompanying drawings, where like numbers designate like parts throughout the several views, and wherein,

FIG. 1 shows an illustrative architecture of an embodiment depicting a DSL demonstration kiosk communicatively connected to a centrally located monitoring system and with other networks such as the Public Switched Telephone Network (PSTN) and the Internet;

FIG. 2 depicts a plurality of kiosks coupled to a server computer that is configured to monitor the kiosks; and

FIG. 3 is a flow chart illustrating steps according to which the principles may be practiced.

### DETAILED DESCRIPTION

A few years ago, access to public data networks—known commonly as the Internet or the web—was viewed as a specialized service, separate from the provisioning of the regular telephone service. In view of this understanding, Internet Service Providers (ISP) such as America Online, Erol's Internet, and others started operating this as a special business apart from the telephone companies. Typically, a user operating a client computer dialed a designated ISP-operated modem bank via his telephone lines. When the modem bank answered the call, the user was connected to a ISP server computer at the ISP location, which computer was configured to allow access to the Internet via a data communication protocol-such as the Point-to-Point Protocol (PPP)—between the client computer and the ISP server computer. In this configuration, the telephone company-and the Public Switching Telephone Network (PSTN)—was viewed as a mere conduit to carry data to and from the client computer.

More recently, telephone companies such as Bell Atlantic (now known as Verizon) started to provide Digital Subscriber Line (DSL) access to end-user consumers. DSL is a technology that allows for an enhanced data rate compared to a standard twisted copper pair lines, though both technologies use the same twisted pair copper lines. Several DSL technologies have been developed to provide different rates of data over a twisted pair. These include Asymmetric Digital Subscriber Line (ADSL), Symmetric Digital Subscriber Line (SDSL), High-speed Digital Subscriber Line (HDSL), Very high bit-rate Digital Subscriber Line (VDSL) and others. These DSL technologies could be used to connect a subscriber station to a service provider station, or between two service provider stations. The ADSL technology, as the name implies, allows for different data rates for inbound (i.e., toward a subscriber station) and outbound (i.e., from the subscriber station). Typically, the ADSL inbound data rate is as high as 1-10 Mbits/sec and the outbound data rate is 50-100 Kbits/sec, and is quite suitable for delivering Internet traffic to subscribers. Though the ADSL is colloquially referred to as DSL, this invention is not limited to ADSL technology, and the present description should be understood to include all the various technologies—including all DSL technologies—and configurations—whether a subscriber or a service provider is located at either or both ends.

As stated above, a kiosk is a self-service station, which is typically used to allow a user to purchase things such as soda, fast food etc. Kiosks have also been in use to allow users to pay for services such as television viewing, web browsing etc. Kiosks are common in large superstores where users are allowed to sample a new offering—a product or a service—before making a purchase. As telephone companies have started providing new services such as the DSL service, they also have started to install kiosks in computer stores from which locations, potential subscribers can sample the services offered by the phone company. Accordingly, demonstration kiosks for DSL service have been installed in stores such as CompUSA®. These kiosks-more particularly, the self-service computer devices installed within the kiosk housings—are assigned static or dynamic IP addresses whereby they can communicate with other devices connected to a network such as the Internet.

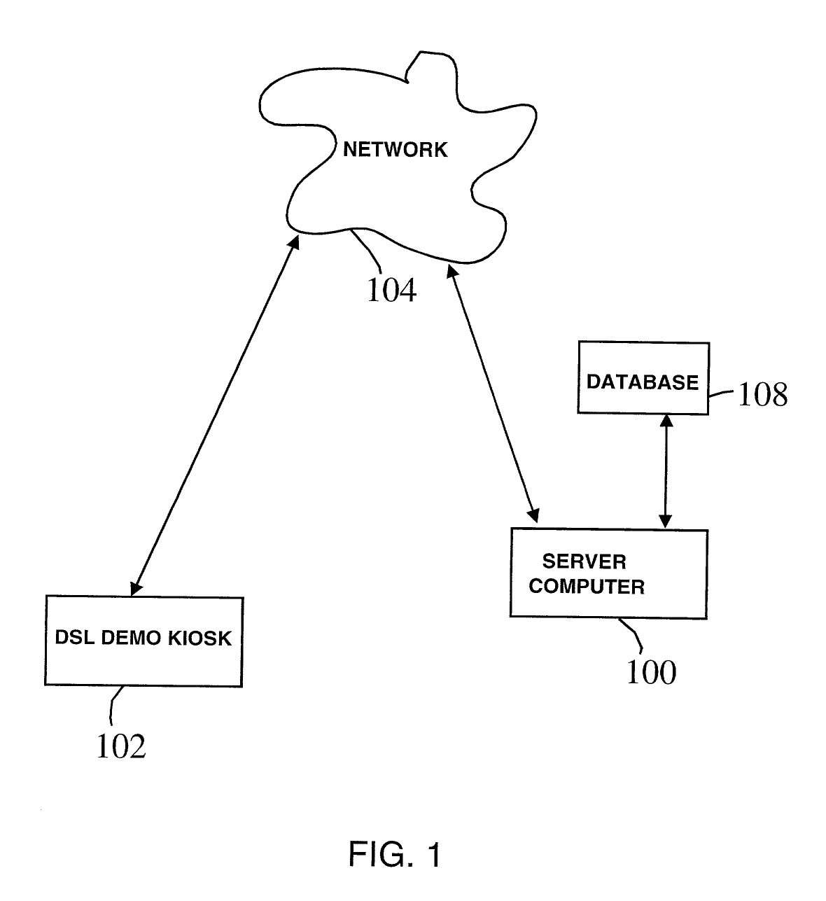

Referring to the drawings, FIG. 1 depicts a server computer 100 communicatively coupled via a connection 106 to a kiosk 102, which is operated by a subscriber (also referred to as a user). The server computer 100 is a part of the interconnected computer networks such as the Internet 104, which is shown separately. The server computer 100 may be programmed to include a database 108, but in other embodiments, the database 108 could be externally located on a different computer coupled to the server computer 100. Suitably, the server computer 100 is located in a central office building or a similar secure building. In an embodiment, the connection 106 is a DSL connection. For the sake of simplicity, components such as DSL access multiplexers (DSLAM), and splitters—to separate voice and data at the central office—are not shown.

In an embodiment, the server computer 100 is a programmed general purpose computer, which includes a microprocessor such as a Compaq™ Alpha™ processor; an operating system such as Windows-NT®, UNIX™ System V Release 4, or Linux™; a memory device such as semiconductor memory; a storage device such as a hard disk; and a communications device such as a network card to connect the server computer 100 to a network such as the Internet 104.

The kiosk 102 is a part of a demonstration kiosk, an example of which is described in U.S. Pat. No. 6,078,848 to Bernstein et al., which description is incorporated herein by reference in its entirety. More particularly, the kiosk 102 includes a processor such as a Pentium® III microprocessor; an operating system such as Windows-NT®; a memory device such as semiconductor memory; an input device such as a keyboard, mouse, microphone, touch-sensitive screen, joystick; and an output device—a display device such as a CRT or a flat panel display, printer or a speaker. The kiosk 102 is connected to the server computer 100 via a DSL connection, which is accomplished by a DSL modem located near the kiosk 102 and another modem at the central office or other similar service-provider location.

The kiosk 102 is optionally equipped with a local hard disk and a removable storage such as a CD-ROM or a floppy disk to allow users to store data on portable media. Also optionally, a metallic or hard plastic housing, such as that used in pay phones manufactured by GTE, Inc. (now Verizon Inc.) or Lucent Technologies, Inc., encapsulates the kiosk 102 to prevent it from tampering by users. To allow users to pay for service, any one of a plurality of methods of payment-such as coin or notes such as a $1 bill, magnetic card reader to read credit, debit pre-paid, or other cards-is additionally provided as an option.

The principles of the present invention can be implemented by programming the server computer 100 and the kiosk 102 in a programming language such as C, C++, Java®, and the like. Further, in alternative embodiments, the method can be implemented using the Java® Runtime Environment®, which can execute on both the kiosk 102 and the server computer 100. The monitoring system may be implemented in the server computer 100 and the kiosk 102 by way of independent memory-resident processes such as UNIX™ processes in the respective computers. In some embodiments, these processes may communicate with each other using inter-process communication methods.

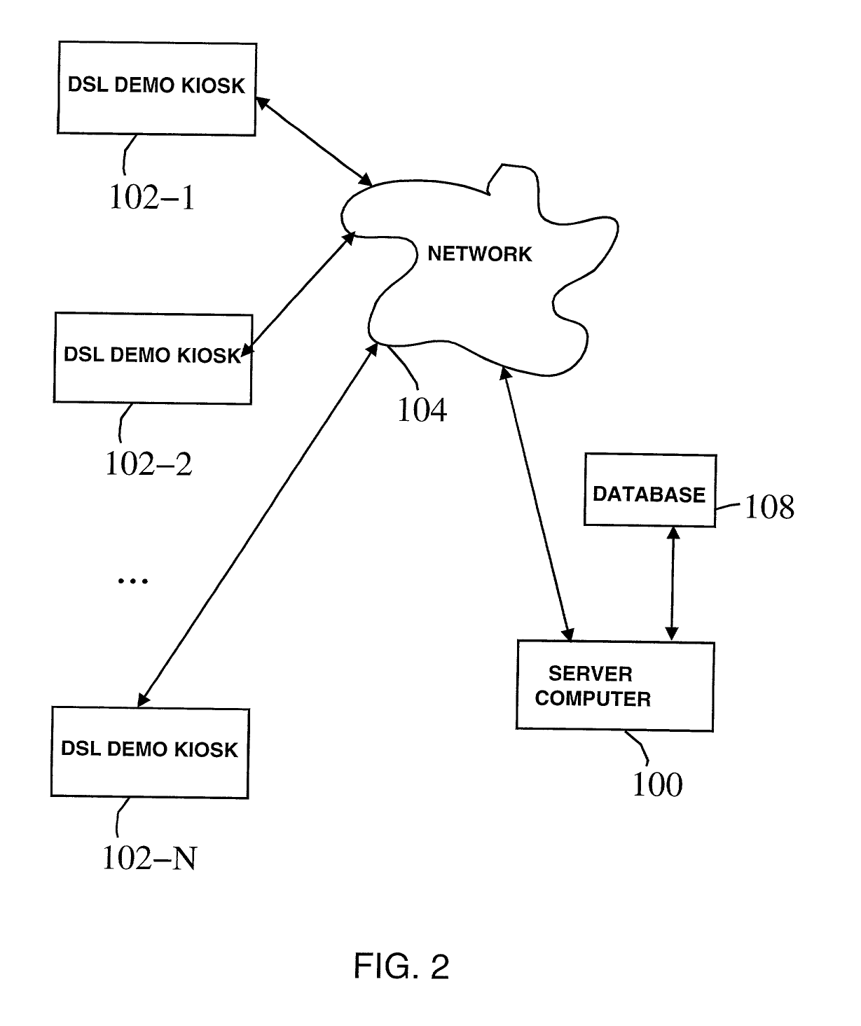

Referring now to FIG. 2, assume that a plurality of kiosks 102-1, 102-2, . . . and 102-N is coupled to the Internet 104. These kiosks could be physically located at different locations such as in the airport, in a department store or in a retail computer store. The monitoring of these kiosks 102-1, 102-2, . . . and 102-N should be understood as an independent activity unrelated to the provisioning of the DSL service itself. The same server computer 100 may monitor each of the kiosks 102-1, 102-2, and 102-N though the kiosks may be coupled to the Internet 104 via different central offices.

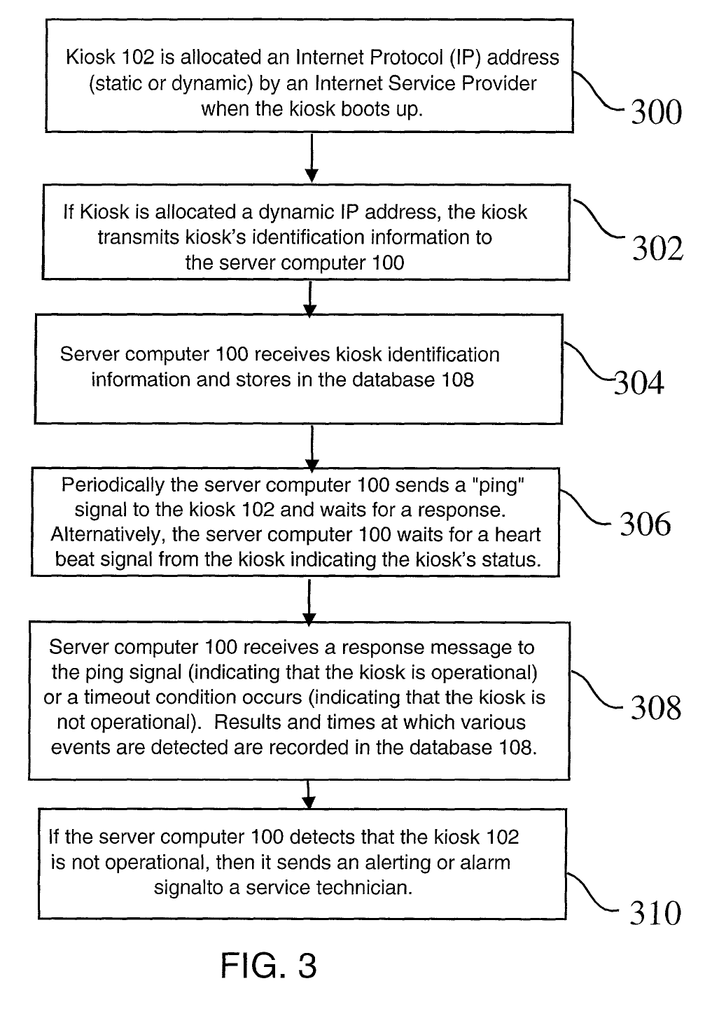

Referring to FIG. 3, the principles of the present method may be implemented by configuring the server computer 100 and the kiosk 102 to perform the steps as shown and as explained in the following. Though the present description contemplates a single computer system kiosk with a DSL connection, the principles disclosed are applicable to other configurations such as when demonstrating wireless devices, multiple devices coupled to the server computer 100, or multiple server computers interconnected with each other. Further, it should be noted that some steps are described only to illustrate the general principles disclosed herein, and not as a limitation, since the steps could be deemed optional, several steps could be collapsed into a single step, or a single step could be implemented in multiple steps.

First, the kiosk 102 is configured to obtain an Internet Protocol (IP) address (step 300), which is a unique address in the Internet space for the kiosk 102. Advantageously, an Internet Service Provider (ISP) such as the telephone company provides the IP address, which is in a dotted-decimal or hexadecimal form, such as XX.YY.ZZ.WW.

The kiosk 102 is programmed to transmit certain identification information to the server computer 100 (step 302). Suitably, this information is transmitted to the server computer 100 when the kiosk 102 is “booted” or initiated, or after a predetermined intervals of time. Advantageously, the kiosk 102 also sends other information identifying information such as the location of the kiosk, and the like. In one embodiment, the kiosk 102 sends one or more packets of data to the server computer 100 via a standard protocol such as Transmission Control Protocol/Internet Protocol (TCP/IP).

The server computer 100 is configured to receive data from the kiosk 102 (step 304). There could be a plurality of kiosks 102 communicatively coupled to the server computer 100, which is configured to function as a central monitoring system by determining which kiosk 102 is active at a particular time. The server computer 104 advantageously sends a signal to the kiosk 102 and listens for a response signal. If the server computer 104 receives the response signal within a predetermined period of time—also called the timeout time period-then, the kiosk 102 is deemed to be “alive.”

In one embodiment, this could be implemented by sending a “ping” signal from the server computer 100 to the kiosk 102 at a “known” IP address of the kiosk 102 (step 306). The IP address is known to the server computer 100 either because the it is a statically allocated IP address, which is programmed into the kiosk 102, and recorded in a table in the database 108 by a system administrator, or because the kiosk 102 notifies the server computer 100 of its dynamically-assigned IP address. A kiosk 102 may notify the server computer 100 of its IP address—which could be statically or dynamically allocated—on a periodic basis.

The “ping” utility, which is an application or utility program provided in computers equipped with communication programs configured to work with the TCP/IP protocol, sends a packet of data to a designated network address, and if the designated address is functional-i.e., whether a computer located at the designated network address (which could be the kiosk 102 in FIG. 1 or any one of 102-1, 102-2, . . . 102-N in FIG. 2) can receive and send signals, messages or packets-then a response signal is returned from the computer located at the designated network address (step 308). In an embodiment, the server computer 100 uses an operating system-provided implementation of a “ping” utility. If such an application is not provided by the operating system, for example, in case of a Java2 platform that does not support the requisite protocols, an external utility may be written in a programming language such as Visual Basic or C++.

Referring to FIG. 2, a second embodiment may include the kiosk 102-2 sending “heartbeat” messages to the server computer 100 to indicate that it was alive. In this embodiment, such heartbeat messages are pre-configured packets of data, which include kiosk identifier and other data pertaining to the kiosk 102-2 such as the number of DSL connections sold at that particular kiosk, and the like.

Suppose a particular kiosk, say 102-2 malfunctions and is out of service. In one embodiment, when the server computer 100 sends a ping signal to kiosk 102-2 at the kiosk's IP address, the ping may return indicating a failed connection with the kiosk 1022. Alternative embodiments may include the server computer 100 communicating with a designated process on the kiosk 102-2.

In another embodiment, the server computer 100 is configured to receive periodic “heart beat” messages from the kiosk 102-2 is additionally programmed to detect the absence of a heart beat message at a prescribed time.

When a failure occurs due to a malfunction by a kiosk 102-2, the time at which the server computer 100 detects the failure and the relevant kiosk identifier are recorded in the database 108.

Sensing that some malfunction could have occurred, the server computer 100 may wait for a predetermined number of failures to occur. If no subsequent failures occur, then the server computer 100 generates a “yellow” alarm, which may indicate a network problem, but not a failure, or a failure and subsequent recovery by the kiosk 102-2. The time at which the server computer 100 detects such as kiosk recovery or network failure is also recorded in the database 108.

On the other hand, if the predetermined number of failures occurs—the server computer 100 may wait for three intervals, for example, to ascertain that the malfunction indeed has occurred—and thereafter generates a “red” alarm or alerting message for a service technician to attend to the kiosk 102-2 (step 310). Suitably, this “red” alarm message could be generated as a paging message sent to a designated paging device, which device would be assigned to a technician on duty. Alternative methods of sending this “red” alarm or alerting messages could be to ring a telephone such as a wireless telephone, to generate an audible or visual alarm on a display device or flashing a light at a designated location.

Further embodiments may include a web-based monitoring system. In this case a user interface is provided to a system administrator via a browser such as Internet Explorer™ marketed by Microsoft Corporation of Redmond, Washington.

The foregoing describes a method of monitoring a DSL demonstration kiosk from a central location, and to transmit to the central location user activity from the kiosk. It should be noted that while transmitting a ping signal is one way of checking if kiosks 102-1, 102-2, . . . 102-N are operational, another method is by viewing the status of any “heart beat” messages sent by the kiosks. Additionally, while a ping signal may be used to verify the status of a kiosk with a static IP address, a “heart beat” message sent by a kiosk and a ping signal may be combined to verify the status of a kiosk for which an IP address is allocated dynamically. Though the principles of the present method are described with reference to certain embodiments, it should be understood that modifications and rearrangements made by persons of ordinary skill in the art without undue experimentation are nevertheless included within the spirit and scope of the following claims.

What is claimed is:

1. A method of indicating the status of a Digital Subscriber (DSL) demonstration kiosk to a centrally located monitoring station, the method comprising the steps of:
establishing a DSL demonstration kiosk at a location accessible for users to sample the services offered by a DSL connection;
connecting the DSL demonstration kiosk to the centrally located monitoring station, said centrally located monitoring station comprising a server computer and a ping utility;
transmitting to the centrally located monitoring station an Internet Protocol (IP) address assigned to the DSL demonstration kiosk; and
periodically transmitting a first message to the centrally located monitoring station, the first message indicative of the status of the DSL demonstration kiosk.

2. The method of claim 1, further comprising the step of:
periodically receiving a ping signal from the centrally located monitoring station.

3. The method of claim 2, wherein the first message is transmitted in response to a ping signal received from the centrally located monitoring station.

4. The method of claim 1, further comprising the step of:
Retransmitting the DSL demonstration kiosk's IP address upon a reboot of the kiosk.

5. The method of claim 1, wherein the first message comprises recorded customer activity at the DSL demonstration kiosk.

6. A method of monitoring a DSL demonstration kiosk from a centrally located monitoring station, the method comprising the steps of:
establishing a connection with the DSL demonstration kiosk;
periodically transmitting a ping signal to the DSL demonstration kiosk;
waiting to receive a first message at a predetermined time, said message indicative of whether the DSL demonstration kiosk is in service;
if the first message is not received at the predetermined time, then recording the time at which the failure of the arrival of the first message is detected; and
generating an alerting message.

7. The method of claim 6 wherein the step of transmitting the ping signal to the DSL demonstration kiosk further comprises the step of:
determining an Internet Protocol (IP) address at which a ping signal may be transmitted to the DSL demonstration kiosk; and
transmitting the ping signal to the IP address.

8. The method of claim 7, wherein the IP address is determined by looking up in a database.

9. The method of claim 7, wherein the IP address is determined from a message received from the DSL demonstration kiosk.

10. The method of claim 6, further comprising the step of:
transmitting the alerting message.

11. The method of claim 10, wherein the alerting message is transmitted to a pager.

12. The method of claim 10, wherein the alerting message is transmitted to a telephone number.
